(19) United States
(12) Patent Application Publication
(10) Pub. No.: US 2017/0031589 A1
(43) Pub. Date: Feb. 2, 2017

(54) INVISIBLE TOUCH TARGET FOR A USER INTERFACE BUTTON

(71) Applicant: Microsoft Technology Licensing, LLC, Redmond, WA (US)

(72) Inventors: Anshul Rawat, Kirkland, WA (US); Benjamin Schoepke, Seattle, WA (US); Henri-Charles Machalani, Seattle, WA (US); Mohammed Samji, Redmond, WA (US)

(73) Assignee: Microsoft Technology Licensing, LLC, Redmond, WA (US)

(21) Appl. No.: 14/812,962

(22) Filed: Jul. 29, 2015

(51) Int. Cl. G06F 3/0488; G06F 3/044; G06F 3/0484; G06F 3/0482; G06F 3/0485

(52) U.S. Cl. CPC G06F 3/04886; G06F 3/0482; G06F 3/0485; G06F 3/04842; G06F 3/04883; G06F 3/044

(57) ABSTRACT

Techniques are described for selecting a user interface (UI) element. A first UI element can be displayed on a computing device, such as a mobile phone. The first UI element can be a graphic, such as an icon. If the first UI element is difficult to reach, due to the size of the computing device, an invisible region on the UI can be selectable that has the same effect as if the first UI element was selected. The invisible region can be a second UI element that overlaps or is spaced apart from the first UI element. Alternatively, selection of the invisible region can be handled at the operating-system level.

### BACKGROUND

Graphical user interfaces (GUIs) are well-known. In a GUI, users interact with electronic devices through graphical icons.

Mobile devices that have a GUI can be sufficiently large that it is difficult for a user to reach a graphical icon or menu item, especially while holding the mobile device with one hand. Some operating systems provide a so-called “reachability” feature. With this feature, a user can temporarily move the UI icons towards a bottom of the screen so that the icons are easier to reach. One problem with this reachability feature is that while some buttons are now easier to reach, others scroll off the screen. Another problem is that selection of an icon can take multiple steps to complete, which is inefficient.

Therefore, there exists ample opportunity for improvement in technologies related to GUIs.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Reaching user interface (UI) elements, such as graphical icons or menu items, can be difficult on larger devices, such as large mobile devices (e.g., phones and tablets). On any such large device, a user's fingers are typically wrapped around the device to hold it leaving just the user's thumbs available to touch UI elements. In one embodiment, an invisible touch target can be added to the UI such that it is more easily reachable by a user. The invisible touch target is associated with the UI element such that selection of either the invisible touch target or the UI element results in an equivalent action by the mobile device. For example, selection of either can result in a same menu or subpage being displayed.

The invisible touch target itself can be a UI element, although invisible, such that it is controlled by an application. Alternatively, the invisible touch target can be an area that, when selected, is controlled by an operating system. In one embodiment, the invisible touch target can be an edge of the display adjacent to the UI element and a tap gesture anywhere along the edge of the display is functionally equivalent to a tap gesture within a touch border of the UI element.

As described herein, a variety of other features and advantages can be incorporated into the technologies as desired.

### BRIEF DESCRIPTION OF THE DRAWINGS

FIG. 1 shows a user interface (UI) having a UI element that can be selected through touching the UI element itself or through touching an invisible region adjacent to the UI element.

FIG. 2 shows another embodiment of the UI, wherein from an edge region of the UI a tap gesture can be received to select a UI element or a swipe gesture can be received from the same region to display a system level menu.

FIG. 3 shows another embodiment of the UI wherein a point within the invisible tap region is selected and the UI automatically scrolls a menu based on a location of where the tap occurred.

FIG. 4 shows a system for implementing the UI including a capacitive touch sensor interacting with an operating system and application in order to display the UI on a computing device.

FIG. 5 is a diagram of an example computing system in which some described embodiments can be implemented.

FIG. 6 is an example mobile device that can be used in conjunction with the embodiments described herein.

FIG. 7 is a method according to one embodiment wherein a UI includes multiple regions for selecting a UI element including an invisible tap region that is easily accessible to a user.

FIG. 8 shows a method according to another embodiment for selecting a UI element using an invisible tap region along an edge of the UI.

FIG. 9 is an example cloud-support environment that can be used in conjunction with the technologies described herein.

### DETAILED DESCRIPTION

### Overview

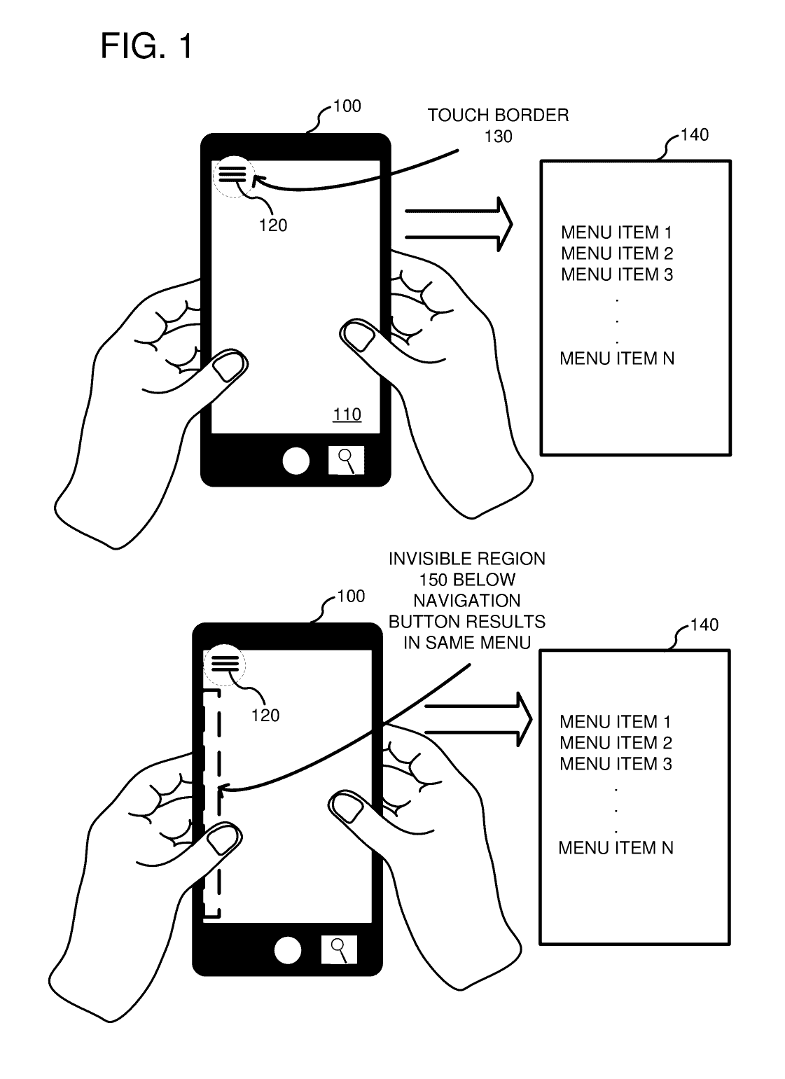

FIG. 1 shows a mobile device 100 with a user interface (UI) 110 through which a user can interact. In this embodiment, the UI includes a UI element 120, shown as a navigation button. The UI element can be any graphic, icon, menu item, etc., which when selected, directs an application or operating system to perform a function, such as display additional information associated with the UI element. The UI element has a touch border 130 encircling it so as to define a region within which a user can select the UI element through touch, such as a tapping gesture. Typically, the touch border 130 is invisible to a user although it is displayed here in dash so as to indicate its position. When a user selects the UI element, a menu 140 is displayed within the display area of the UI 110. The menu includes any number of menu items (N, where N is any integer number) and can be any format. Although a menu is displayed, this embodiment can be extended or replaced with other functionality, such as displaying information or pages associated with an application. Because of how users typically hold the mobile device 100, it can be difficult to reach UI element 120. An invisible region 150 is shown below the UI element 120 in dash lines (wherein dash lines indicates that it is not visible to a user). The invisible region 150 can be a separate UI element associated with an application, or it can be a system-level function handled through the operating system of the mobile device. In either case, a tap on or within the invisible region 150 displays a same menu 140 that is displayed when the UI element 120 is selected. The invisible region 150 is easier to reach than UI element 120 as it is located in a natural position for reaching with a user's thumb when holding the mobile device with one or both thumbs located on the display and the user's remaining fingers on a backside of the mobile device. Thus, two different and separate areas of the UI 110 result in a same menu 140 being displayed. The invisible region 150 is shown as extending along an edge of the UI adjacent to the UI element 120. Although shown as spaced apart, the invisible region 150 can overlap with the touch border region 130 of the UI element. The invisible region 150 allows a user to easily reach the UI element 120 regardless of a size of the mobile device 100. The invisible region or zone 150 can extend below, above or adjacent to a UI element 120. In one particular implementation, the invisible region 150 can be a single pixel wide or other widths (e.g., up to about the width of the UI element 120) and extend from the bottom of the UI to the top, and even potentially overlapping with the touch border 130 of the UI element 120. The particular location of the invisible region can be changed based on the design.

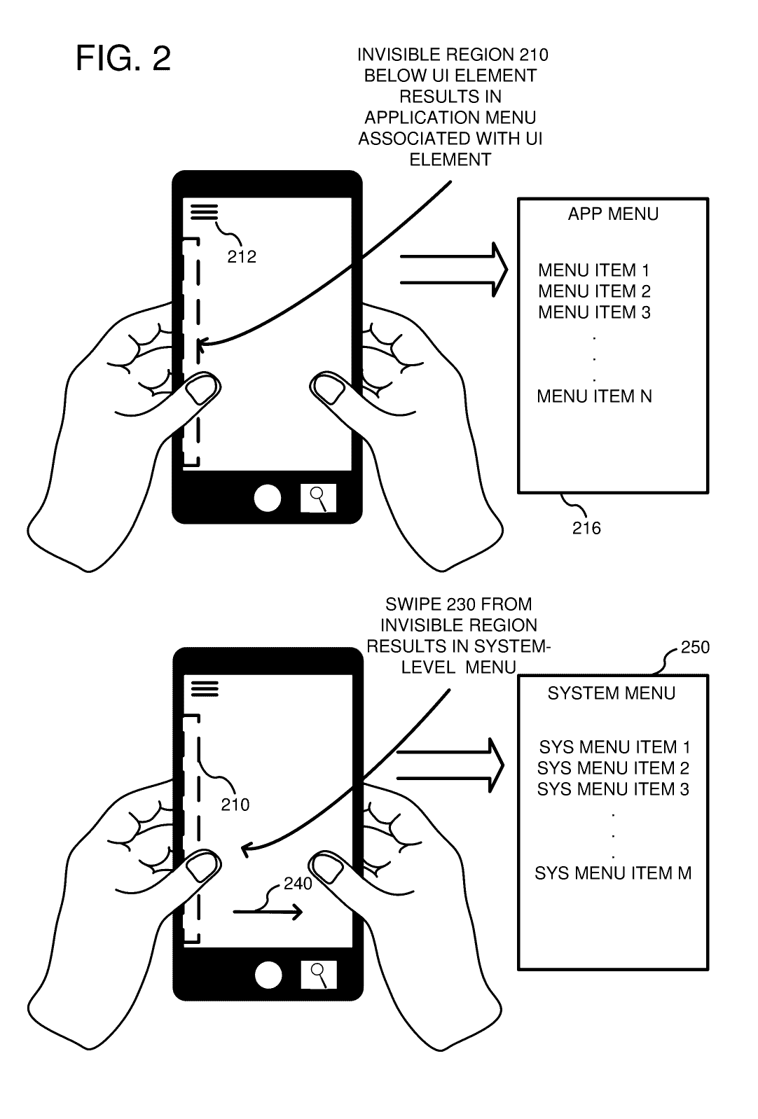

FIG. 2 shows another embodiment of a UI wherein a swipe operation is integrated into functionality that can be performed by a user, together with an invisible tap region. As shown, a user can tap an invisible region 210 below a UI element 212 in order to select the UI element. As previously described, the tapping of the invisible region 210 results in a menu 216 being displayed. As shown at 230, a swipe from a region adjacent to the invisible tap region 210 or within the invisible tap region 210 in a direction shown by arrow 240 results in the display of a different menu 250, which is a system-level menu. Thus, the source of the menus 216 and 250 are from different parts or components of the system. More particularly, the application menu 216 is generated by an application, whereas the system-level menu 250 is generated by an operating system. Furthermore, the application and the operating system execute simultaneously. As is well understood in the art, either one or both of the menus 216, 250 can be replaced with other content or functionality associated with the operating system or the application.

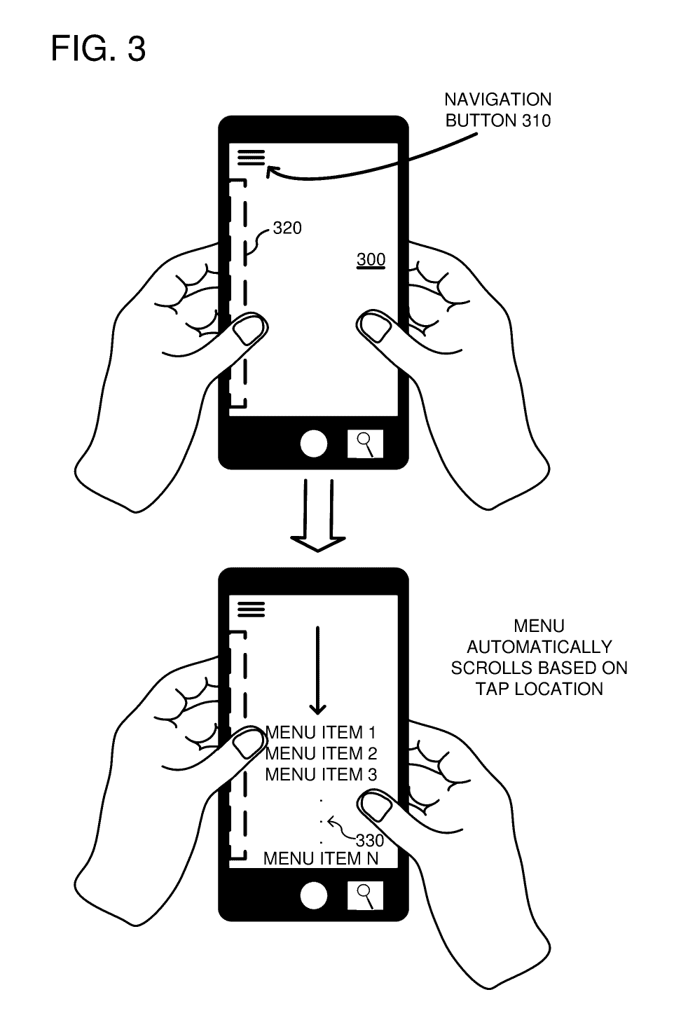

FIG. 3 shows an additional UI feature that can be integrated into the embodiments shown in FIGS. 1 and 2. In this embodiment, a UI 300 includes a UI element, shown as a navigation button 310, and an invisible second UI element 320, which when tapped is equivalent to a selection of the navigation button 310. Because of the way that users typically hold a mobile device, the navigation button 310 is not easily reachable with a user's thumb. As shown, the second UI element can be an elongated element extending from or near a bottom edge of the UI 300 to either adjacent to the navigation button 310 or overlapping the navigation button 310. A user can tap at multiple tap point locations along the entire length of the second UI element 320. As can readily be seen, the UI element 320 is easily reachable with the user's thumb in multiple locations along a side of the mobile device. As the result of the tap (i.e., selection), a menu or other content can be displayed. Depending on the location where the user tapped, the menu items 330 can automatically scroll to an advantageous position for the user to reach those menu items. Consequently, an assumption is made that where the user tapped on the second UI element is a same location in which the UI 300 is reachable. In order to effectuate the automatic scrolling of the menu items, a location along the length of the second UI element can be determined through XY coordinates and transmitted to the application associated with the navigation button 310. Correspondingly, the application can then determine where to scroll the menu based on the XY coordinates.

### Example Interaction Between Software and Hardware Components

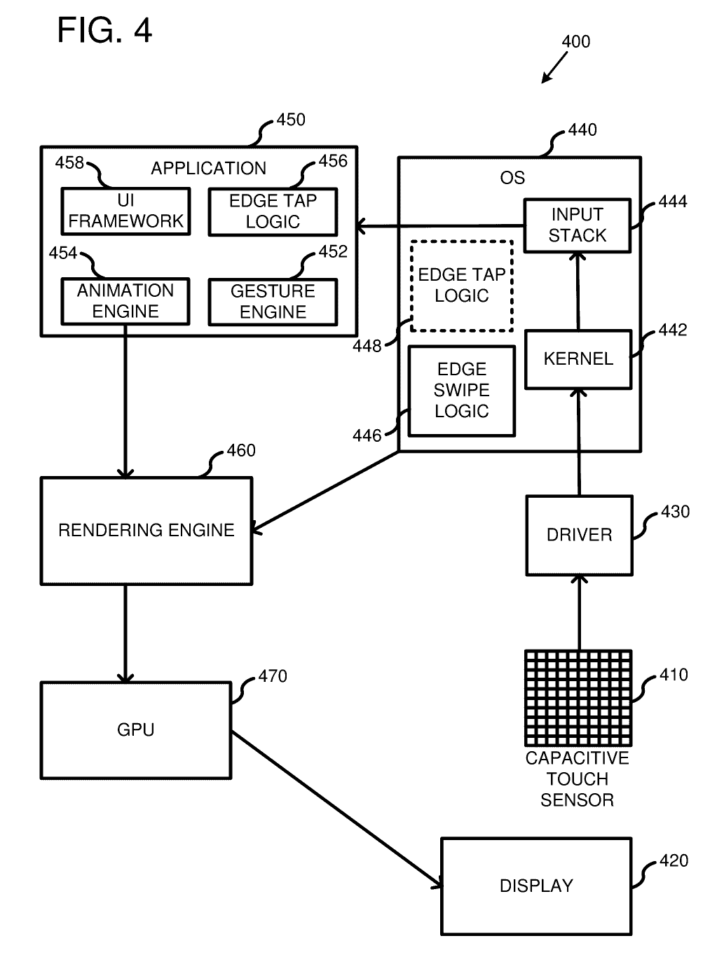

FIG. 4 shows an example system 400 in which the embodiments described herein can be implemented. A capacitive touch sensor 410 can be positioned beneath the surface of a display 420. As is well understood in the art, the capacitive touch sensor 410 includes a plurality of XY components that mirror the surface area of the display and can be used to determine a location where a user touched the display. A driver 430 can be used to receive the capacitive touch sensor outputs, including the XY coordinates, and place the corresponding input data in a format needed to pass to an operating system 440. The operating system includes an operating system kernel 442, and input stack 444, edge swipe logic 446, and edge tap logic 448, which is shown in dashed lines as it can be positioned within the operating system 440 or within an application 450. The kernel 442 receives the input data and determines whether it can perform an operation based on the coordinate information or whether the XY coordinates are to be passed to the application 450. For example, when the XY coordinates are in conjunction with a swipe gesture, then the kernel 442 can use the edge swipe logic 446 to determine what action to perform. The kernel can then pass information to be displayed to a rendering engine 460, which transmits information to be displayed on the display 420 through use of a graphics processing unit (GPU) 470. If, on the other hand, the kernel 442 decides that the data is to be passed to the application 450, it places the data into the input stack 444. Through either a push or pull operation, the XY coordinates and associated data can be passed to the application 450 from the input stack.

The application 450 includes a gesture engine 452, an animation engine 454, edge tap logic 456, and a UI framework 458. When data is input to the application from the input stack 444, the gesture engine 452 can be used to interpret the user gesture that occurred. The gesture engine 452, in cooperation with the UI framework 458, can use the XY coordinates from the input stack to determine which UI element on the display was activated or selected. For example, the UI framework can determine that UI element 120 (FIG. 1) was selected and can initiate a display in response to the selection. If an edge tap was detected, the gesture engine 452 can use the edge tap logic 456 to determine the information to display on the display 420. Once the UI framework 458 and gesture engine 452 determine what should be displayed, the information can be passed from the animation engine 454 to the rendering engine 460, which is generally outside of the application. Then the rendering engine 460 determines how the information will be displayed on the display 420 and passes the necessary information to the GPU 470 for display.

Notably, the edge tap logic 456, 448 can be positioned within the application 450 or the operating system 440. Thus, a response to the user edge tap gesture can be a system-level response from the operating system 440 or an application-level response from the application 450, depending on the design. In the case where the operating system 440 is displaying information in response to the edge tap gesture, the edge of the display is not considered a second UI element in addition to the navigation button or other buttons on the UI. Instead of being a UI element, the operating system 440 detects when an edge of the display is tapped. In this case, using the edge tap logic 448, the operating system understands how to modify the display so as to respond to the edge tap gesture. If the edge tap logic is at an application level, then the edge of the display is considered a UI element and the application responds accordingly.

In the example of FIG. 4, edge tap logic is shown as corresponding to the invisible region (e.g., see 150 in FIG. 1). However, the invisible region in any of the embodiments described herein need not be along the edge of the display. Indeed, the invisible region can correspond to any selectable area on the display that is outside of the touch border 130 (see FIG. 1). Depending on the implementation, the edge tap components 456, 448 can be replaced with components corresponding to the location of the invisible region.

### Example Computing Device

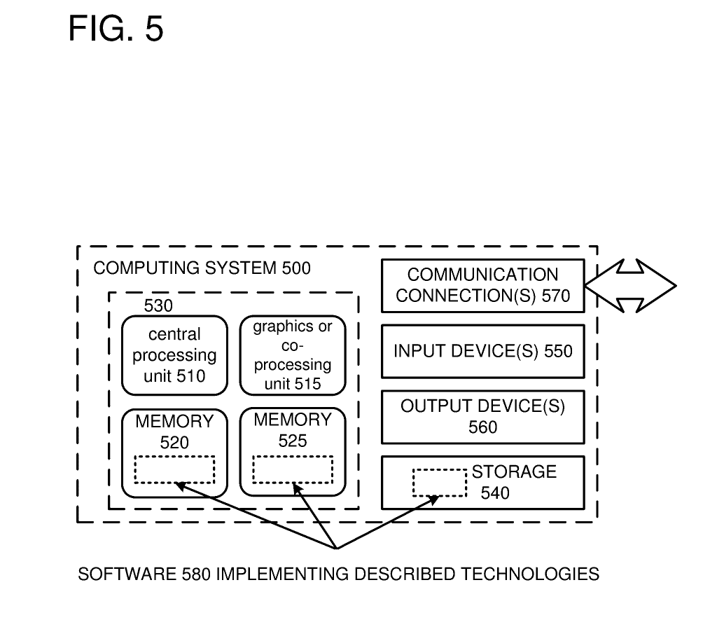

FIG. 5 depicts a generalized example of a suitable computing system 500 in which the described innovations may be implemented. The computing system 500 is not intended to suggest any limitation as to scope of use or functionality, as the innovations may be implemented in diverse general-purpose or special-purpose computing systems.

With reference to FIG. 5, the computing system 500 includes one or more processing units 510, 515 (one of which can correspond to GPU 470) and memory 520, 525. In FIG. 5, this basic configuration 530 is included within a dashed line. The processing units 510, 515 execute computer-executable instructions. A processing unit can be a general-purpose central processing unit (CPU), processor in an application-specific integrated circuit (ASIC), or any other type of processor. In a multi-processing system, multiple processing units execute computer-executable instructions to increase processing power. For example, FIG. 5 shows a central processing unit 510 as well as a graphics processing unit or co-processing unit 515. The tangible memory 520, 525 may be volatile memory (e.g., registers, cache, RAM), nonvolatile memory (e.g., ROM, EEPROM, flash memory, etc.), or some combination of the two, accessible by the processing unit(s). The memory 520, 525 stores software 580 implementing one or more innovations described herein, in the form of computer-executable instructions suitable for execution by the processing unit(s).

A computing system may have additional features. For example, the computing system 500 includes storage 540, one or more input devices 550, one or more output devices 560, and one or more communication connections 570. An interconnection mechanism (not shown) such as a bus, controller, or network interconnects the components of the computing system 500. Typically, operating system software (not shown) provides an operating environment for other software executing in the computing system 500, and coordinates activities of the components of the computing system 500.

The tangible storage 540 may be removable or non-removable, and includes magnetic disks, magnetic tapes or cassettes, CD-ROMs, DVDs, or any other medium which can be used to store information and which can be accessed within the computing system 500. The storage 540 stores instructions for the software 580 implementing one or more innovations described herein.

The input device(s) 550 may be a touch input device such as a keyboard, mouse, pen, or trackball, a voice input device, a scanning device, touch screen or another device that provides input to the computing system 500. The output device(s) 560 may be a display, printer, speaker, CD-writer, or another device that provides output from the computing system 500.

The communication connection(s) 570 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-executable instructions, such as those included in program modules, being executed in a computing system on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system.

The terms “system” and “device” are used interchangeably herein. Unless the context clearly indicates otherwise, neither term implies any limitation on a type of computing system or computing device. In general, a computing system or computing device can be local or distributed, and can include any combination of special-purpose hardware and/or general-purpose hardware with software implementing the functionality described herein.

For the sake of presentation, the detailed description uses terms like “determine” and “use” to describe computer operations in a computing system. These terms are high-level abstractions for operations performed by a computer, and should not be confused with acts performed by a human being. The actual computer operations corresponding to these terms vary depending on implementation.

### Example Mobile Device

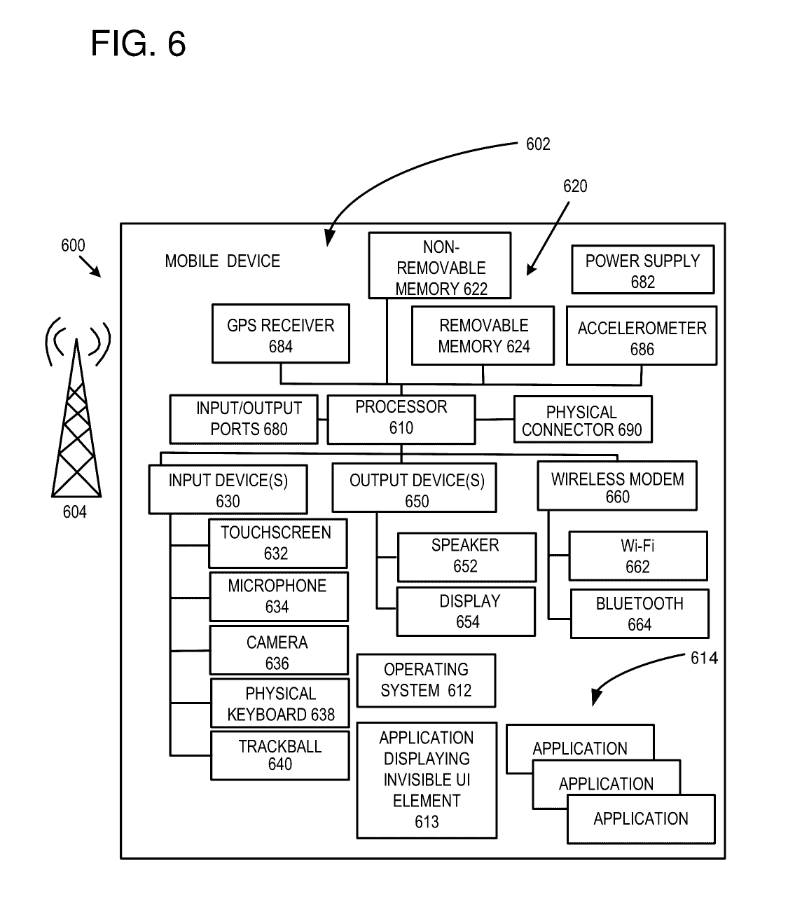

FIG. 6 is a system diagram depicting an example mobile device 600 including a variety of optional hardware and software components, shown generally at 602. Any components 602 in the mobile device can communicate with any other component, although not all connections are shown, for ease of illustration. The mobile device can be any of a variety of computing devices (e.g., cell phone, smartphone, handheld computer, Personal Digital Assistant (PDA), etc.) and can allow wireless two-way communications with one or more mobile communications networks 604, such as a cellular, satellite, or other network.

The illustrated mobile device 600 can include a controller or processor 610 (e.g., signal processor, microprocessor, ASIC, GPU or other control and processing logic circuitry) for performing such tasks as signal coding, data processing, input/output processing, power control, displaying information and/or other functions. An operating system 612 can control the allocation and usage of the components 602 and support for one or more application programs 614. The application programs can include common mobile computing applications (e.g., email applications, calendars, contact managers, web browsers, messaging applications), or any other computing application. An application 613 can be used for displaying the invisible UI element, as described herein. Other applications can also be executing on the mobile device 600.

The illustrated mobile device 600 can include memory 620. Memory 620 can include non-removable memory 622 and/or removable memory 624. The non-removable memory 622 can include RAM, ROM, flash memory, a hard disk, or other well-known memory storage technologies. The removable memory 624 can include flash memory or a Subscriber Identity Module (SIM) card, which is well known in GSM communication systems, or other well-known memory storage technologies, such as “smart cards.” The memory 620 can be used for storing data and/or code for running the operating system 612 and the applications 614. Example data can include web pages, text, images, sound files, video data, or other data sets to be sent to and/or received from one or more network servers or other devices via one or more wired or wireless networks. The memory 620 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

The mobile device 600 can support one or more input devices 630, such as a touchscreen 632 (including its associated capacitive touch sensor), microphone 634, camera 636, physical keyboard 638 and/or trackball 640 and one or more output devices 650, such as a speaker 652 and a display 654. Other possible output devices (not shown) can include piezoelectric or other haptic output devices. Some devices can serve more than one input/output function. For example, touchscreen 632 and display 654 can be combined in a single input/output device.

The input devices 630 can include a Natural UI (NUI). An NUI is any interface technology that enables a user to interact with a device in a “natural” manner, free from artificial constraints imposed by input devices such as mice, keyboards, remote controls, and the like. Examples of NUI methods include those relying on speech recognition, touch and stylus recognition, gesture recognition both on screen and adjacent to the screen, air gestures, head and eye tracking, voice and speech, vision, touch, gestures, and machine intelligence. Other examples of a NUI include motion gesture detection using accelerometers/gyroscopes, facial recognition, 3D displays, head, eye, and gaze tracking, immersive augmented reality and virtual reality systems, all of which provide a more natural interface, as well as technologies for sensing brain activity using electric field sensing electrodes (EEG and related methods). Thus, in one specific example, the operating system 612 or applications 614 can comprise speech-recognition software as part of a voice UI that allows a user to operate the device 600 via voice commands. Further, the device 600 can comprise input devices and software that allows for user interaction via a user's spatial gestures, such as detecting and interpreting gestures to provide input to an application.

A wireless modem 660 can be coupled to an antenna (not shown) and can support two-way communications between the processor 610 and external devices, as is well understood in the art. The modem 660 is shown generically and can include a cellular modem for communicating with the mobile communication network 604 and/or other radio-based modems (e.g., Bluetooth 664 or Wi-Fi 662). The wireless modem 660 is typically configured for communication with one or more cellular networks, such as a GSM network for data and voice communications within a single cellular network, between cellular networks, or between the mobile device and a public switched telephone network (PSTN).

The mobile device can further include at least one input/output port 680, a power supply 682, a satellite navigation system receiver 684, such as a Global Positioning System (GPS) receiver, an accelerometer 686, and/or a physical connector 690, which can be a USB port, IEEE 1394 (FireWire) port, and/or RS-232 port. The illustrated components 602 are not required or all-inclusive, as any components can be deleted and other components can be added.

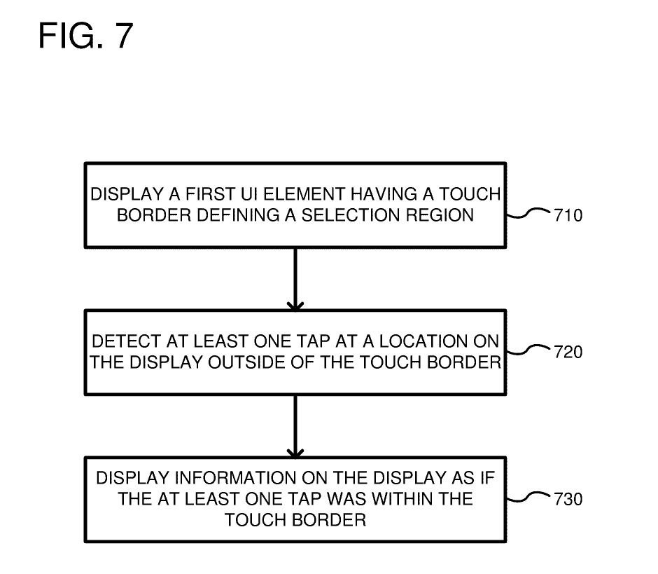

FIG. 7 is a flowchart of a method for selecting a UI element. In process block 710, a first UI element having a touch border defining a selection region is displayed. The touch border is an invisible area around a UI element (e.g., a graphic) and whenever a user taps or touches within the touch border the UI element is considered selected. The selection region or area is typically defined by the application that is associated with the UI element. If the capacitive touch sensor 410 detects a touch at an XY coordinate that corresponds to the selection region of the UI element, then the application 450 considers the UI element selected. In process block 720, at least one tap is detected at a location on the display outside of the touch border. Consequently, in normal operation the application 450 would not consider that the first UI element has been selected because of the sensing outside of the selection region. However, in this embodiment, there is an invisible region separate from the first UI element which, when tapped, responds as if the first UI element was selected. For example, an invisible region 150 (FIG. 1), can be along the left edge having a pixel width of 1, 2, 3, or 4 pixels wide. Other pixel widths can also be used. The dashed line at 150 shows that the selection region can be long so that selection can be accomplished at multiple different XY coordinates. In process block 730, information on the display is displayed as if the at least one tap was within the touch border of the first UI element. Thus, despite that the user did not select the UI element, the display information associated with the first UI element can be displayed to the user. The displaying of information in process block 730 can be initiated from the application 450 or through the operating system 440.

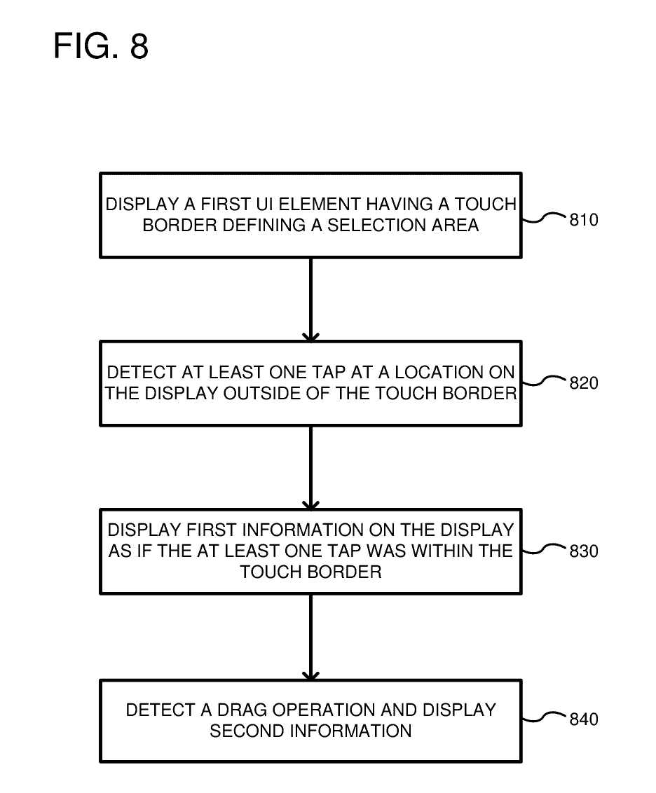

FIG. 8 shows a flowchart according to another embodiment for selecting a UI element. In process block 810, a first UI element having a touch border that defines a selection area is displayed. In process block 820, at least one tap is detected at a location on the display outside of the touch border of the first UI element but within an invisible region. In process block 830, the first information on the display is displayed as if the tap was within the touch border. Thus, as previously described, an edge of the display can be detected and used as either a second UI element that is associated with the first UI element or, at a system level, a detection of an edge can result in a display of information associated with the first UI element. In process block 840, a drag operation is detected from a same location or a location that overlaps with the location identified at 820. This drag operation results in a system level display of information such as a menu associated with the operation system. Thus, both tap and swipe gestures can be associated with a same invisible region.

Example Cloud-Supported Environment

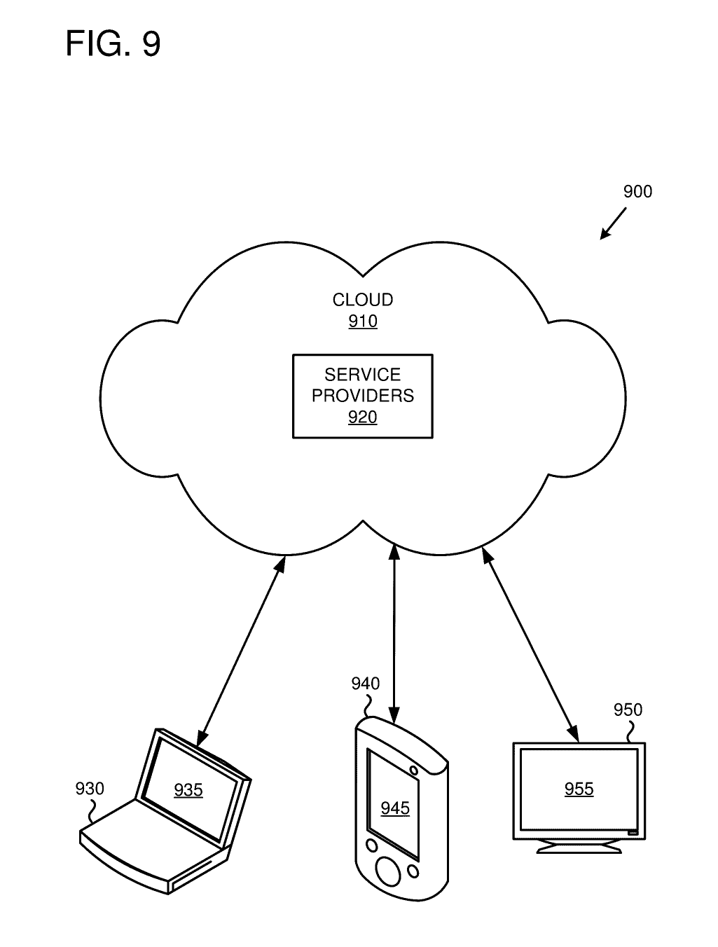

FIG. 9 illustrates a generalized example of a suitable cloud-supported environment 900 in which described embodiments, techniques, and technologies may be implemented. In the example environment 900, various types of services (e.g., computing services) are provided by a cloud 910. For example, the cloud 910 can comprise a collection of computing devices, which may be located centrally or distributed, that provide cloud-based services to various types of users and devices connected via a network such as the Internet. The implementation environment 900 can be used in different ways to accomplish computing tasks. For example, some tasks (e.g., processing user input and presenting a UI) can be performed on local computing devices (e.g., connected devices 930, 940, 950) while other tasks (e.g., storage of data to be used in subsequent processing) can be performed in the cloud 910.

In example environment 900, the cloud 910 provides services for connected devices 930, 940, 950 with a variety of screen capabilities. Connected device 930 represents a device with a computer screen 935 (e.g., a mid-size screen). For example, connected device 930 could be a personal computer, such as desktop computer, laptop, notebook, netbook, or the like. Connected device 940 represents a device with a mobile device screen 945 (e.g., a small size screen). For example, connected device 940 could be a mobile phone, smart phone, personal digital assistant, tablet computer, and the like. Connected device 950 represents a device with a large screen 955. For example, connected device 950 could be a television screen (e.g., a smart television) or another device connected to a television (e.g., a set-top box or gaming console) or the like. One or more of the connected devices 930, 940, 950 can include touchscreen capabilities and the embodiments described herein can be applied to any of these touchscreens. Touchscreens can accept input in different ways. For example, capacitive touchscreens detect touch input when an object (e.g., a fingertip or stylus) distorts or interrupts an electrical current running across the surface. As another example, touchscreens can use optical sensors to detect touch input when beams from the optical sensors are interrupted. Physical contact with the surface of the screen is not necessary for input to be detected by some touchscreens. Any of these touchscreens can be used in place of or in addition to capacitive touch sensor 410. Devices without screen capabilities also can be used in example environment 900. For example, the cloud 910 can provide services for one or more computers (e.g., server computers) without displays.

Services can be provided by the cloud 910 through service providers 920, or through other providers of online services (not depicted). For example, cloud services can be customized to the screen size, display capability, and/or touchscreen capability of a particular connected device (e.g., connected devices 930, 940, 950).

In example environment 900, the cloud 910 provides the technologies and solutions described herein to the various connected devices 930, 940, 950 using, at least in part, the service providers 920. For example, the service providers 920 can provide a centralized solution for various cloud-based services. The service providers 920 can manage service subscriptions for users and/or devices (e.g., for the connected devices 930, 940, 950 and/or their respective users).

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions or a computer program product stored on one or more computer-readable storage media and executed on a computing device (e.g., any available computing device, including smart phones or other mobile devices that include computing hardware). Computer-readable storage media are any available tangible media that can be accessed within a computing environment (e.g., one or more optical media discs such as DVD or CD, volatile memory components (such as DRAM or SRAM), or nonvolatile memory components (such as flash memory or hard drives)). The term computer-readable storage media does not include signals and carrier waves. In addition, the term computer-readable storage media does not include communication connections.

Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, C#, Java, Perl, JavaScript, Adobe Flash, or any other suitable programming language. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and sub combinations with one another. The disclosed methods, apparatus, and systems are not limited to any specific aspect or feature or combination thereof, nor do the disclosed embodiments require that any one or more specific advantages be present or problems be solved.

### Alternative Embodiments

Various combinations of the embodiments described herein can be implemented. For example components described in one embodiment can be included in other embodiments and vice versa. The following paragraphs are non-limiting examples of such combinations:

A. A computing device comprising:

a processing unit;

a display coupled to the processing unit, the display having a surface that is touchable by a user;

a touch screen sensor positioned below the surface of the display;

a selectable first user interface (UI) element configured to be displayed on the display;

an invisible second UI element configured to be positioned on the display;

the computing device configured to perform operations in response to selection, by tapping, of the invisible second UI element that are equivalent to selection of the first UI element so that selection of either the first UI element or the second UI element are equivalent.

B. The computing device of paragraph A, wherein the invisible second UI element is along an edge of the display adjacent to the first UI element.

C. The computing device of paragraphs A or B, wherein the computing device is further configured to detect one of a plurality of possible tap points within the invisible second UI element, and automatically scrolling a menu displayed on the display so that the menu is easily reachable from the detected tap point.

D. The computing device of paragraphs A through C, wherein the touch screen sensor is a capacitive touch screen sensor.

E. The computing device of paragraphs A through D, wherein the computing device is configured so that selection of the first UI element results in a display of a first menu and selection of the invisible second UI element results in a display of a same first menu.

F. The computing device of paragraphs A through E, wherein an application executing on the processing unit performs the equivalent operations regardless of whether the first UI element or the second UI element are selected.

G. The computing device of paragraphs A through F, wherein the computing device is configured to perform a system-level function in response to a drag operation from a location on the display that overlaps with the invisible second UI element.

H. A method, implemented by a computing device, for selecting a user interface (UI) element, the method comprising:

displaying a first UI element on a display of the computing device, the first UI element having a touch border defining a region within which the first UI element is selected when tapped;

detecting, using a touch sensor within the computing device, at least one tap at a location on the display outside of the touch border of the first UI element;

displaying information on the display of the computing device as if the at least one tap was within the touch border of the first UI element.

I. The method of paragraph H, wherein displaying information includes displaying a menu associated with the first UI element, despite that the first UI element was not tapped within the touch border.

J. The method of paragraph H or I, wherein the displaying of the information is initiated by an application executing on the computing device.

K. The method of paragraphs H through J, wherein the displaying of the information is initiated by an operating system executing on the computing device.

L. The method of paragraphs H through K, wherein the detection of the at least one tap is along an edge of the display.

M. The method of paragraphs H through L, further including providing a second UI element having a different touch border than the first UI element and the detecting of the at least one tap is within the touch border of the second UI element.

N. The method of paragraphs H through N, wherein the information is first information and further including detecting a drag operation initiated at a same location on the display as the at least one tap and displaying second information, different than the first information.

O. The method of paragraphs H through N, wherein an application generates the displaying of the first information and an operating system generates the displaying of the second information.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope of these claims.

What is claimed is:

1. A computing device comprising:
a processing unit;
a display coupled to the processing unit, the display having a surface that is touchable by a user;
a touch screen sensor positioned below the surface of the display;
a selectable first user interface (UI) element configured to be displayed on the display;
an invisible second UI element configured to be positioned on the display;
the computing device configured to perform operations in response to selection, by tapping, of the invisible second UI element that are equivalent to selection of the first UI element so that selection of either the first UI element or the second UI element are equivalent.

2. The computing device of claim 1, wherein the invisible second UI element is along an edge of the display adjacent to the first UI element.

3. The computing device of claim 1, wherein the computing device is further configured to detect one of a plurality of possible tap points within the invisible second UI element, and automatically scrolling a menu displayed on the display so that the menu is easily reachable from the detected tap point.

4. The computing device of claim 1, wherein the touch screen sensor is a capacitive touch screen sensor.

5. The computing device of claim 1, wherein the computing device is configured so that selection of the first UI element results in a display of a first menu and selection of the invisible second UI element results in a display of a same first menu.

6. The computing device of claim 1, wherein an application executing on the processing unit performs the equivalent operations regardless of whether the first UI element or the second UI element are selected.

7. The computing device of claim 6, wherein the computing device is configured to perform a system-level function in response to a drag operation from a location on the display that overlaps with the invisible second UI element.

8. A method, implemented by a computing device, for selecting a user interface (UI) element, the method comprising:
displaying a first UI element on a display of the computing device, the first UI element having a touch border defining a region within which the first UI element is selected when tapped;
detecting, using a touch sensor within the computing device, at least one tap at a location on the display outside of the touch border of the first UI element;
displaying information on the display of the computing device as if the at least one tap was within the touch border of the first UI element.

9. The method of claim 8, wherein displaying information includes displaying a menu associated with the first UI element, despite that the first UI element was not tapped within the touch border.

10. The method of claim 8, wherein the displaying of the information is initiated by an application executing on the computing device.

11. The method of claim 8, wherein the displaying of the information is initiated by an operating system executing on the computing device.

12. The method of claim 8, wherein the detection of the at least one tap is along an edge of the display.

13. The method of claim 8, further including providing a second UI element having a different touch border than the first UI element and the detecting of the at least one tap is within the touch border of the second UI element.

14. The method of claim 8, wherein the information is first information and further including detecting a drag operation initiated at a same location on the display as the at least one tap and displaying second information, different than the first information.

15. The method of claim 14, wherein an application generates the displaying of the first information and an operating system generates the displaying of the second information.

16. A computer-readable storage medium storing computer-executable instructions for causing a computing device to perform operations for selecting a user interface (UI) element, the operations comprising:
display a first UI element using an application on the computing device, the first UI element having a border area defining a selectable region of the first UI element on a display of the computing device;
detect a tapping at a location on the display outside of the border area so that the first UI element is not selected;
in response to the detection of the tapping, display first information as if the first UI element was selected; and
detect a drag operation at the location on the display and, in response, display second information, different than the first information.

17. The computer-readable storage medium of claim 16, wherein the second information is generated at an operating-system level.

18. The computer-readable storage medium of claim 16, wherein the operations further comprise:
scroll the first information based on the location so that the first information is accessible to the user.

19. The computer-readable storage medium of claim 16, wherein the operations further include:
provide an invisible second UI element at the location of the display, and wherein the display of the first information is in response to the selection of the invisible second UI element.

20. The computer-readable storage medium of claim 16, wherein the detecting of the tapping includes detecting the tapping along an edge of the display adjacent to the first UI element.
